(19) United States
(12) Patent Application Publication
(10) Pub. No.: US 2019/0194455 A1
(43) Pub. Date: Jun. 27, 2019

(54) POLYAMIDES COMPRISING (PER)FLUOROPOLYETHER AND POLY(ORGANO SILOXANE) UNITS

(71) Applicant: SOLVAY SPECIALTY POLYMERS ITALY S.P.A., Bollate (IT)

(72) Inventors: Ritu AHUJA, Singapore (SG); Chinmay NARDELE, Vadodara, Gujarat (IN); Claudio Adolfo Pietro TONELLI, Paderno D'Adda (IT); Ivan Diego WLASSICS, Garessio (IT)

(21) Appl. No.: 16/329,199

(22) PCT Filed: Aug. 9, 2017
(86) PCT No.: PCT/EP2017/070137

§ 371 Date: Feb. 27, 2019

(30) Foreign Application Priority Data
Aug. 31, 2016 (IN) 201621029827
Oct. 20, 2016 (EP) 16194847.6

(51) Int. Cl. C08L 77/02; C08L 77/06; C08K 7/14; C08G 69/40; C08G 69/42

(52) U.S. Cl. CPC C08L 77/02; C08L 77/06; C08K 7/14; B29C 45/0001; C08G 69/42; C08L 2203/02; C08L 2203/20; C08G 69/40

(57) ABSTRACT

Thermoplastic polyamides [polyamides (PA)] comprising (per)fluoropolyether and polyorganosiloxane recurring units are herein disclosed. Thanks to the use of appropriate amounts and ratios of (per)fluoropolyether and polyorganosiloxane monomers in the polymerization, polyamides (PA) are endowed with high hydro- and oleo-repellence, favourable mechanical properties and resistance to stain, which makes them suitable for a variety applications, including the manufacture and/or surface treatment of medical articles, fuel line hoses, miniature circuit breakers, electrical switches, smart devices, devices for printers, and food packagings.

### CROSS-REFERENCE TO PREVIOUS APPLICATIONS

This application claims priority to Indian provisional application No. 201621029827 filed on 31 Aug. 2016 and European patent application EP 16194847.6 filed on 20 Oct. 2016. The whole content of these applications is incorporated herein by reference for all purposes.

### TECHNICAL FIELD

The present invention relates to polyamides, namely to polyamides modified with (per)fluoropolyether and poly(organo siloxane) units, methods for the manufacture of said polyamides and formed articles obtainable therefrom.

### BACKGROUND ART

Polydimethylsiloxane (PDMS), also called “dimethicone”, complying with formula CH₃[Si(CH₃)₂O]ₙSi(CH₃)₃, where n is the number of repeating [SiO(CH₃)₂] units, is the most widely used silicon-based organic polymer. As it is non-flammable, non-toxic, permeable, and optically clear, it is advantageously used in the manufacture of cosmetics, pharmaceuticals, biomedical devices, like catheters for haemodialysis, and contact lenses. PDMS is highly oleophilic and highly hydrophobic. Such high oleophilicity combined with high hydrophobicity facilitates the adherence of bacteria, platelets, proteins and other biomolecules to the surface of biomedical devices; this may lead to malfunctioning of the devices and, in certain instances, also cause infections in patients using the same. For this reason, intense studies have been carried out in order to provide modified PDMS suitable for long-term biomedical applications. For example, it has been proposed to covalently graft a cross-linked poly(poly(ethylene glycol) dimethacrylate) (P(PEGDMA)) polymer layer on medical-grade silicon surfaces to improve their antibacterial and antifouling properties (LI, M., et al. Surface modification of silicone for biomedical applications requiring long-term antibacterial, antifouling, and hemocompatible properties. Langmuir. 2012, vol. 28, no. 47, p. 16408-22.)

It is known that fully or partially fluorinated polyethers [herein after also referred to as “(per)fluoropolyether(s)” or “PFPE(s)”] can be used as additives for other polymers in order to modify certain physical/chemical properties of the host polymers. It has been observed that, when PFPEs are physically blended to other polymers to form compositions, they tend to segregate and to migrate to the surface during processing; in some instances, the separation of the PFPE from the composition might reduce the durability of the composition and of the finished article obtained therefrom. Moreover and more important, in several applications (e.g. biomedical applications), the risk of separation of chemical components from compositions represents a toxicological concern, so the use of additives is not acceptable.

PFPEs can also be used as comonomers (sometimes referred to as “comacromers”, due to their high molecular weight) in polymerization reactions, thereby obtaining modified polymers comprising PFPE segments (or units) covalently incorporated in the polymers.

Modified polymers comprising both PFPE and siloxane segments are known in the art.

For example, WO 96/31791 (GIBA GEIGY AG) Oct. 10, 1996 discloses a macromer for use in the manufacture of contact lenses, said macromer comprising polysiloxane segments, perfluoroalkylether segments and other divalent segments which can be bound to the siloxane and/or perfluoroalkylether segments via amide bonds. However, the amount of PDMS and PFPE segments is high and the resulting polymer is elastomeric.

EP 0819140 A (COMMONWEALTH SCIENTIFIC AND INDUSTRIAL RESEARCH ORGANIZATION) Jan. 21, 1998 discloses a macromonomer having general formula:

Q-PFPE-L-M-L-PFPE-Q

wherein:
Q may be the same or different and is a polymerizable group;
PFPE may be the same or different and is a perfluorinated straight chain polyether segment;
L may be the same or different and is a difunctional linking group;

and M is a residue from a difunctional polymer or copolymer wherein M has a molecular weight of 180 to 6000 comprising silicone repeat units of formula

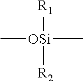

where R₁ and R₂ may be the same or different and are selected from the group consisting of hydrogen, alkyl, aryl, halosubstituted alkyl, and the like. The macromonomer can be used in the production of contact lenses, corneal implants, cell growth substrates or medical implants.

FR 2831 432 (OREAL) May 2, 2003 discloses broadly discloses a cosmetic composition comprising a polycondensation product, including a polyamide comprising at least one polyorganosiloxane segment and at least one perfluoroalkyl or perfluoropolyether segment; however, this document does not point to the selection of polyamides modified with polyorganosiloxane and PFPE segments and to specific amounts of polyorganosiloxane and PFPE segments with respect to the overall weight of a polyamide recurring units.

US 2003232948 (PICKERING JERRY A) Dec. 18, 2003 discloses a block copolymer comprising at least one polyorganosiloxane block, at least one organomer block, and at least one group, or linkage, in particular at least one polar group, or polar linkage, covalently bonding a polyorganosiloxane block and an organomer block. The at least one organomer block comprises at least one member selected from the group consisting of hydrocarbyl blocks and perhalopolyether blocks. The block copolymer can be used as release agent in toner fusing systems.

US 2008071042 (SHIN ETSU CHEMICAL CO. LTD.) Mar. 20, 2008 discloses a PFPE-polyorganosiloxane copolymer comprising at least one PFPE block, at least one polyorganosiloxane block (block W) which may have a silalkylene group, and two monovalent silicon-containing terminal groups. The PFPE and the polyorganosiloxane block are preferably connected by a connecting group Q to form a backbone of formula:

—(R_{f}-Q)ₕ-(W-Q-R_{f}-Q)_{g}-W-(Q-R_{f})ᵢ—

wherein Q is a divalent connecting group having 2 to 12 carbon atoms and may contain a bond comprising an oxygen and/or nitrogen atom, including the amido bond, g is an integer from 0 to 10 and I is 0 or 1. The copolymer is said to possess excellent adhesion to substrates and curing properties and is said to be suitable for the manufacture of surface treatment compositions.

US 2012/0264890 (HANSEN RICHARD G et al) Oct. 18, 2012 discloses copolymers containing at least one PFPE segment and at least one polydiorganosiloxane segment joined together by aminooxalylamino groups. In particular, examples 1 discloses a polyamide obtained by reaction of a 25K oxylaminoester-terminated PDMS with H₂NCH₂CH₂NH(CO)—HFPO—(CO)NHCH₂NH₂ (wherein HFPO stands for poly(hexafluoropropyleneoxide).

US 20150133602 (THE BOEING COMPANY) May 14, 2015 discloses a method of synthesizing an elastomeric segmented copolymer, namely a PDMS-urethane/urea segmented copolymer, which comprises the reaction of a hydroxy-terminated polysiloxane with a diisocyanate to obtain a first reaction product, and the reaction of this reaction product with a diamine or diol chain extender and, optionally, also with a PFPE diol.

WO 2013/172177 (DAIKIN INDUSTRIES LTD) Nov. 21, 2013 relates to a fluoropolyether-group-containing silicone compound wherein a PFPE and a siloxane segment are joined together by a group of formula:

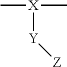

wherein X is a trivalent organic group; Y is a divalent organic group; Z is a silyl group containing a hydrolyzable site. The compound is suitable for use as surface-treating agent and is said to possess anti-fouling properties.

An emulsion comprising a polyurethane modified with PDMS and PFPE segments is disclosed in DU, Yang, et al. Study on Waterborne Polyurethanes based on Poly(dimethyl siloxane) and Perfluorinated Polyether. Macromolecuar research. 2015, vol. 23, no. 9, p. 867-875. The authors teach that, thanks to the presence of the PDMS segments and of the PFPE segments, the hydrophobic properties of the polyurethane were improved.

Polyamides modified with PFPEs, i.e. polyamides in which a functional PFPE is used as monomer in the course of the polymerization are also known.

U.S. Pat. No. 3,876,617 (MONTEDISON SPA) Apr. 8, 1975 discloses elastomeric polyamides and copolyamides which can be obtained by reacting a PFPE diacid, preferably in the form of a reactive derivative, with a diamine. In particular, in U.S. Pat. No. 3,876,617 it is stated that the polyamides can also contain further monomeric units with more than two functions, like polycarboxylic acids, to an extent up to 30% in number with respect to the bifunctional units. The amount of PFPE diacid contained in these polyamides is high and, for this reason, the resulting polyamide is endowed with elastomeric properties.

WO 2015/097076 (SOLVAY SPECIALTY POLYMERS ITALY SPA) Jul. 2, 2015 discloses a thermoplastic polyamide (PA) consisting of recurring units derived from monomers (A) and (B), wherein monomer (A) is selected from at least one of:

(i) a mixture of:
one or more hydrogenated aliphatic, cycloaliphatic or aromatic diamine(s) [amine (NN)] or derivative(s) thereof; and
one or more hydrogenated aliphatic, cycloaliphatic or aromatic dicarboxylic acid(s) [acid (DA)] or derivative(s) thereof;

(ii) one or more aminoacid(s) [aminoacid (AN)] or lactam(s) [lactam (L)] and wherein monomer (B) is at least one (per)fluoropolyether monomer (PFPE-M) selected from a PFPE-diamine (PFPE-NN) and PFPE-dicarboxylic acid (PFPE-AA),

characterised in that the amount of monomer (B) ranges from 0.1% to 10% wt, preferably from 1% to 5% wt, with respect to the overall weight of monomers (A) and (B).

The presence of the PFPE monomer (B) in the polyamide allows improving surface properties, in particular hydro- and oleophobicity with respect to non-modified polyamides and, at the same time, increases chemical resistance and reduces brittleness, thereby avoiding or reducing the need for impact modifiers.

### SUMMARY OF INVENTION

The Applicant has now found out that the use of both functional polyorganosiloxanes and functional PFPEs as comonomers in the synthesis of polyamides allows obtaining modified thermoplastic polyamides endowed with high hydro- and oleophobicity; surprisingly, the Applicant has found out that inserting PDMS segments into polyamides comprising PFPE segments increases hydrophobicity without decreasing the oleophobicity imparted to the polyamide by the PFPE segments.

Accordingly, the present invention relates to a polyamide [polyamide (PA)] consisting of recurring units derived from monomers (A), (B) and (C) or derivatives thereof wherein:

monomer (A) is selected from at least one of:

(i) a mixture of:
one or more aliphatic, cycloaliphatic or aromatic diamine(s) [amine (NN)]; and
one or more aliphatic, cycloaliphatic or aromatic dicarboxylic acid(s) [acid (AA)];

(ii) one or more aminoacid(s) [aminoacid (AN)] or lactam(s) [lactam (L)];

monomer (B) is a functional (per)fluoropolyether selected from at least one of:
a (per)fluoropolyether dicarboxylic acid (PFPE-AA) and
a (per)fluoropolyether diamine (PFPE-NN) and

monomer (C) is a functional polyorganosiloxane selected from at least one of:
a diamino-polyorganosiloxane (PSIL-NN) and
a dicarboxy-polyorganosiloxane (PSIL-AA)

characterized in that the overall amount of recurring units derived from monomers (B) and (C) ranges from 0.1 to 20% wt with respect to the overall weight of recurring units derived from monomers (A), (B) and (C).

The invention further relates to a method for the manufacture of the polyamide (PA), to compositions comprising polyamide (PA) and to formed articles obtained therefrom.

### GENERAL DEFINITIONS AND SYMBOLS

For the sake of clarity, throughout the present application:
any reference back to each generic embodiment of the invention is intended to include each specific embodiment falling within the respective generic embodiment, unless indicated otherwise;
the term “(per)fluoropolyether” stands for “fully or partially fluorinated polyether”;
the acronym “PFPE” stands for “(per)fluoropolyether” as defined above; when used as substantive, “PFPE” and “PFPEs” respectively denote the singular or the plural form;
the use of brackets “( )” before and after symbols or numbers identifying compounds or formulae, e.g. “polyamide (PA)”, “diamine (NN)”, “diacid (AA)”, etc. . . , has the mere purpose of better distinguishing those symbols or numbers from the rest of the text; thus, said parentheses could also be omitted;
the expression “recurring units derived from monomers (A), (B) and (C)” identifies recurring units derives from such monomers or from derivatives thereof, said units being linked together through amido bonds;
the expression “derivatives thereof” referred to monomers (A), (B) and (C) means derivatives able to form amide bonds;
when numerical ranges are indicated, range ends are included;
“(halo)alkyl” is a straight or branched alkyl group optionally substituted with one or more halogen atoms independently selected from chlorine, fluorine, bromine and iodine;
a “cycloalkyl group” is a univalent group derived from a cycloalkane by removal of an atom of hydrogen; the cycloalkyl group thus comprises one end which is a free electron of a carbon atom contained in the cycle, which able to form a linkage with another chemical group;
a “divalent cycloalkyl group” is a divalent radical derived from a cycloalkane by removal of two atoms of hydrogen from two different carbons in the cycle; a divalent cycloalkyl group thus comprises two ends, each being able to form a linkage with another chemical group;
the adjective “aromatic” denotes any mono- or polynuclear cyclic group (or moiety) having a number of π electrons equal to 4n+2, wherein n is 0 or any positive integer; an aromatic group (or moiety) can be an aryl or an arylene group (or moiety);
an “aryl group” is a hydrocarbon monovalent group consisting of one core composed of one benzenic ring or of a plurality of benzenic rings fused together by sharing two or more neighboring ring carbon atoms, and of one end. Non limitative examples of aryl groups are phenyl, naphthyl, anthryl, phenanthryl, tetracenyl, triphenylyl, pyrenyl, and perylenyl groups. The end of an aryl group is a free electron of a carbon atom contained in a (or the) benzenic ring of the aryl group, wherein an hydrogen atom linked to said carbon atom has been removed. The end of an aryl group is capable of forming a linkage with another chemical group;
an “arylene group” is a hydrocarbon divalent group consisting of one core composed of one benzenic ring or of a plurality of benzenic rings fused together by sharing two or more neighboring ring carbon atoms, and of two ends. Non limitative examples of arylene groups are phenylenes, naphthylenes, anthrylenes, phenanthrylenes, tetracenylenes, triphenylylenes, pyrenylenes, and perylenylenes. An end of an arylene group is a free electron of a carbon atom contained in a (or the) benzenic ring of the arylene group, wherein an hydrogen atom linked to said carbon atom has been removed. Each end of an arylene group is capable of forming a linkage with another chemical group.

### DETAILED DESCRIPTION ON POLYAMIDE (PA)

### Monomer (A)

Amine (NN) is generally selected from the group consisting of primary and secondary alkylene-diamines, cycloaliphatic diamines, aromatic diamines and mixtures thereof.

Amine (NN) typically complies with general formula (NN-I)

R—HN—R^{1A}—NH—R′ (NN-I)

wherein:
R and R′, equal to or different from one another, are selected from hydrogen, straight or branched C₁-C₂₀ alkyl and aryl as defined above, preferably phenyl;
R^{1A} is: (i) a straight or branched aliphatic alkylene chain having 2 to 36 carbon atoms, optionally comprising one or more divalent cycloalkyl groups or arylene groups as defined above; (ii) a divalent cycloalkyl group or (iii) an arylene group as defined above.

In amine (NN-I), a divalent cycloalkyl group preferably comprises from 3 to 6 carbon atoms, and, optionally, one or more oxygen or sulphur atoms.

In one embodiment, diamine (NN) is a primary alkylene diamine. Primary alkylene diamines are advantageously selected from the group consisting of 1,2-diaminoethane, 1,2-diaminopropane, propylene-1,3-diamine, 1,3-diaminobutane, 1,4-diaminobutane, 1,5-diaminopentane, 1,5-diamino-2-methyl-pentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,8-diamino-2-methyloctane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane, 1,12-diaminododecane, and 1,13-diaminotridecane. The aliphatic alkylene diamine preferably comprises at least one diamine selected from the group consisting of 1,2-diaminoethane, 1,4-diamino butane, 1,6-diaminohexane, 1,8-diamino-octane, 1,10-diaminodecane, 1,12-diaminododecane and mixtures thereof. More preferably, the aliphatic alkylene diamine is selected from 1,2-diaminoethane, 1,6-diaminohexane, 1,10-diaminodecane and mixtures thereof.

Examples of primary alkylene diamines wherein the alkylene chain comprises an arylene group are meta-xylylene diamine (MXDA), and para-xylylene diamine. More preferably, the diamine is MXDA.

In another embodiment, amine (NN) is a secondary diamine. Non-limiting examples of secondary diamines are N-methylethyelene diamine, N,N′-diethyl-1,3-propanediamine, N,N′-diisopropylethylenediamine, N,N′-diisopropyl-1,3-propanediamine and N,N-diphenyl-para-phenylenediamine.

Derivatives of amine (NN) able to form amide groups can be used for in the manufacture of polyamides (PA); convenient examples of such derivatives are amine (NN) salts.

Acid (AA) can be an aliphatic dicarboxylic acid [diacid (AL)] or a dicarboxylic acid comprising at least one aryl or arylene group as defined above [diacid (AR)]. Non limitative examples of diacids (AR) are notably phthalic acids, including isophthalic acid (IA), and terephthalic acid (TA), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, naphthalene dicarboxylic acids, including 2,6-naphthalene dicarboxylic acid, 2,7-naphthalene dicarboxylic acid,1,4-naphthalene dicarboxylic acid, 2,3-naphthalene dicarboxylic acid, 1,8-naphthalene dicarboxylic acid. Conveniently, acid (AA) is isophthalic acid (IA) or terephthalic acid (TA). Among diacids (AL), mention can be notably made of oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tetradecanedioic acid [HOOC—(CH₂)₁₂—COOH], octadecanedioic acid [HOOC—(CH₂)₁₆—COOH], 2,5-furandicarboxylic acid and tetrahydrofuran-2,5-dicarboxylic acid. Convenient examples of diacids (AL) are adipic acid and sebacic acid; more conveniently, diacid (AL) is adipic acid.

Derivatives of acids (AA) able to form amide groups can be used in the manufacture of polyamides (PA); such derivatives include notably salts, anhydrides, esters and acid halides.

Among suitable aminoacids (AN) for the manufacture of the polyamide (PA), mention can be made of those selected from the group consisting of 6-amino-hexanoic acid, 9-aminononanoic acid, 10-aminodecanoic acid, 11-aminoundecanoic acid, 12-aminododecanoic acid. Derivatives of aminoacids (AN) able to form amide groups can also be used for the manufacture of polyamide (PA); such derivatives include, notably, salts, esters and acid halides.

Non-limiting examples of suitable lactams (L) for the manufacture of polyamide (PA) are β-lactam and ε-caprolactam.

### Monomer (B)

As stated above, monomer (B) [hereinafter also referred to as “(PFPE-M)” is a functional (per)fluoropolyether selected from at least one of:
a (per)fluoropolyether dicarboxylic acid (PFPE-AA) and
a (per)fluoropolyether diamine (PFPE-NN).

(PFPE-AA) comprises a fully or partially fluorinated polyalkyleneoxy chain [(per)fluoropolyoxylakylene chain (R_{f})] having two chain ends, wherein each chain end comprises a —COOH group or a derivative thereof as defined above, preferably an ester or a halide.

(PFPE-NN) comprises a fully or partially fluorinated polyalkyleneoxy chain [(per)fluoropolyoxylakylene chain (R_{f})] having two chain ends, wherein each chain end comprises an amino group or a derivative thereof as defined above.

For the sake of clarity, throughout the present description and claims, the expressions “(PFPE-AA)” and “(PFPE-NN)” are meant to encompass also PFPE-AA and PFPE-NN in admixture with the corresponding monocarboxylic acids (PFPE-A) or monoamine (PFPE-N) and non-functional PFPEs. Indeed, certain (PFPE-AA) and (PFPE-NN) are usually obtained in admixture with corresponding monocarboxylic acids (PFPE-A) or monoamine (PFPE-N) and non-functional PFPEs. (PFPE-AA) and (PFPE-NN) particularly suitable for use in the present invention have an average functionality (F_{B}) of at least 1.80, preferably of at least 1.95. Average functionality (F) is defined as:

[2× moles of (PFPE-AA) or (PFPE-NN)+1× moles of PFPE monocarboxylic acid or monoamine)/(moles of non-functional PFPE+moles of PFPE monocarboxylic acid or monoamine+moles of PFPE dicarboxylic acid or diamine].

Average functionality (F_{B}) can be calculated by means of ¹H-NMR and ¹⁹F-NMR analyses according to methods known in the art, for example following the teaching of U.S. Pat. No. 5,910,614 (AUSIMONT SPA) with suitable modifications.

Chain (R_{f}) comprises recurring units R^{o} having at least one catenary ether bond and at least one fluorocarbon moiety, said repeating units, randomly distributed along the chain, being selected from the group consisting of:

(i) —CFXO—, wherein X is F or CF₃,

(ii) —CFXCFXO—, wherein X, equal or different at each occurrence, is F or CF₃, with the proviso that at least one of X is —F,

(iii) —CF₂CF₂CW₂O—, wherein each of W, equal or different from each other, is F, Cl, H,

(iv) —CF₂CF₂CF₂CF₂O—,

(v) —(CF₂)ⱼ—CFZ*—O— wherein j is an integer from 0 to 3 and Z* is a group of general formula —OR_{f}*T*, wherein R_{f}* is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of X being independently F or CF₃ and T* being a C₁-C₃ perfluoroalkyl group.

Preferably, chain (R_{f}) complies with the following formula:

—(CFX¹O)_{g1}(CFX²CFX³O)_{g2}(CF₂CF₂CF₂O)_{g3}(CF₂CF₂CF₂CF₂O)_{g4}— (R_{f}-I)

wherein:
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—(CF₂CF₂O)ₐ₁(CF₂O)ₐ₂— (R_{f}-IIA)

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10, more preferably between 0.3 to 3;

—(CF₂CF₂O)_{b1}(CF₂O)_{b2}(CF(CF₃)O)_{b3}(CF₂CF(CF₃)O)_{b4}— (R_{f}-IIB)

wherein:

b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being ≥1;

—(CF₂CF₂O)_{c1}(CF₂O)_{c2}(CF₂(CF₂)_{cw}CF₂O)_{c3}— (R_{f}-IIC)

wherein:

cw=1 or 2;

c1, c2, and c3 are independently integers ≥0 chosen so that the number average molecular weight is between 400 and 10,000, preferably between 400 and 5,000; preferably c1, c2 and c3 are all >0, with the ratio c3/(c1+c2) being generally lower than 0.2;

—(CF₂CF(CF₃)O)_{d}— (R_{f}-IID)

wherein:

d is an integer >0 such that the number average molecular weight is between 400 and 10,000, preferably between 400 and 5,000;

—(CF₂CF₂C(Hal)₂O)ₑ₁—(CF₂CF₂CH₂O)ₑ₂—(CF₂CF₂CH(Hal)O)ₑ₃— (R_{f}-IIE)

wherein:
Hal, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—(CF₂CF₂O)ₐ₁(CF₂O)ₐ₂— (R_{f}-III)

wherein:
a1, and a2 are integers >0 such that the number average molecular weight is between 400 and 5,000, with the ratio a2/a1 generally ranging from 0.3 to 3.

(PFPE-M) preferably complies with general formula (I) here below:

A-O—R_{f}-A′ (I)

wherein:
R_{f} is as defined above;
A and A′, equal to or different from one another, represent a C₁-C₃ haloalkyl group, typically selected from —CF₃, —CF₂Cl, —CF₂CF₂Cl, —C₃F₆Cl, —CF₂Br and —CF₂CF₃ or a group of formula:

CF₂-Lₓ-T

in which:
L represents a bivalent radical selected from:

(a) a C₁-C₂₀ straight or branched C₃-C₂₀ alkylene chain (Cₐₗₖ), optionally containing one or more heteroatoms selected from O, N, S and P and/or one or more groups of formula —C(O)—, —C(O)O—, —OC(O)O—, —C(O)NH—, —NHC(O)NH— and —C(O)S—, said chain optionally containing a (heterocyclo)aliphatic ring (Rₐₗᵢ) or (heterocycloaromatic) ring (Rₐᵣ) as defined herein below;

(b) a C₃-C₁₀ cycloaliphatic ring (Rₐₗᵢ), optionally substituted with one or more straight or branched alkyl groups, preferably C₁-C₃ alkyl groups, and optionally containing one or more heteroatoms selected from N, O, S or groups of formula —C(O)—, —C(O)O— and —C(O)NH; the cycloaliphatic ring can also be linked to or condensed with a further ring (Rₐₗᵢ) or with a C₅-C₁₂ aromatic or heteroaromatic ring (Rₐᵣ) as defined herein below, which can optionally be substituted with one or more straight or branched alkyl groups, preferably C₁-C₃ alkyl groups;

(c) a C₅-C₁₂ aromatic ring (Rₐᵣ), optionally containing one or more heteroatoms selected from N, O, S and optionally being substituted with one or more straight or branched alkyl groups, preferably C₁-C₃ alkyl groups; optionally, ring (Rₐᵣ) can be linked to or condensed with another equal or different ring (Rₐᵣ);
x is 0 or 1;
T is a —COOH or —NHR_{B} group, wherein R_{B} is hydrogen or a straight or branched alkyl group, preferably a C₁-C₄ straight or branched alkyl group, more preferably a methyl group, or a derivative thereof as defined above.

Typically, in groups CF₂-Lₓ-T, x is 1 and linking group L comprises one of the following groups W¹, said group W¹ being directly bound to the —CF₂— group between chain (R_{f}) and linking group L: —CH₂O—, —CH₂OC(O)NH—, —CH₂NR¹— in which R¹ is hydrogen or straight or branched C₁-C₃ alkyl, and —C(O)NH—. It has indeed been observed that monomers (B) wherein x is 1 are advantageous in that they are particularly reactive and compatible with amines (NN) and acids (AA) and in that they are also thermally and chemically stable.

Preferred examples of (PFPE-M) are those wherein A and/or A′ are selected from the following groups:

(a¹) —CF₂CH₂O-alkylene-T;

(b¹) —CF₂CH₂O(alkylene-O)ₙ—C*ₐₗₖ-T;

(c¹) —CF₂CH₂O-alkylene-C(O)NH-alkylene-T;

(d¹) —CF₂CH₂NR¹-alkylene-T;

(e¹) —CF₂CH₂NR¹(alkylene-NR¹)ₙ—C*ₐₗₖ-T;

(f¹) —CF₂CH₂NR¹-alkylene-C(O)O-alkylene-T;

(g¹) —CF₂CH₂NR¹-alkylene-C(O)NH-alkylene-T;

(h¹) —CF₂C(O)NH—(C*ₐₗₖ)-T

(i¹) —CF₂C(O)NH—(R*ₐₗᵢ)-T; and

(l¹) —CF₂C(O)NH—(R*ₐᵣ)-T

wherein:
alkylene is a C₁-C₂₀ straight or branched C₃-C₂₀ alkylene chain, preferably a C₁-C₁₂ chain;
n is a positive number ranging from 1 to 10, preferably from 1 to 5, more preferably from 1 to 3, extremes included;
T is as defined above;
R¹ is as defined above;
C*ₐₗₖ, R*ₐₗᵢ and R*ₐᵣ have the same meanings as Cₐₗₖ, Rₐₗᵢ and Rₐᵣ defined above.

In (PFPE-M) wherein A and/or A′ are groups of formula (b¹), preferred (alkylene-O) moieties include —CH₂CH₂O—, —CH₂CH(CH₃)O—, —(CH₂)₃O— and —(CH₂)₄O—.

(PFPE-M) wherein x is 1 and L comprises a W¹ group selected from —CH₂O—, —CH₂OC(O)NH— and —CH₂NR¹— in which R¹ is as defined above can be obtained using as precursor a PFPE alcohol of formula (II) below:

Y—O—R_{f}—Y′ (II)

wherein R_{f} is as defined above and Y and Y′, equal to or different from one another, represent a C₁-C₃ haloalkyl group, typically selected from —CF₃, —CF₂Cl, —CF₂CF₂Cl, —C₃F₆Cl, —CF₂Br and —CF₂CF₃ or a group of formula —CF₂CH₂OH.

Suitable PFPE alcohols of formula (II) can be prepared by photoinitiated oxidative polymerization (photooxidation reaction) of per(halo)fluoromonomers, as described in U.S. Pat. No. 3,715,378 (MONTECATINI EDISON SPA) and U.S. Pat. No. 366,541 (MONTEDISON SPA). Typically, mixtures of perfluoropolyethers can be obtained by combination of hexafluoropropylene and/or tetrafluoroethylene with oxygen at low temperatures, in general below −40° C., under U.V. irradiation, at a wavelength (A) of less than 3 000 Å. Subsequent conversion of end-groups as described in U.S. Pat. No. 3,847,978 (MONTEDISON SPA) and in U.S. Pat. No. 3,810,874 (MINNESOTA MINING) notably carried out on crude products from photooxidation reaction.

(PFPE-M) wherein W¹ is —CH₂O— can be obtained by reaction of a PFPE alcohol (II) with a compound of formula E-B*-T, wherein E represents a leaving group, B* represents a group selected from C*ₐₗₖ, R*ₐₗᵢ and R*ₐᵣ and T is amino or carboxy, optionally in a protected form. Suitable leaving groups E include halogens, preferably chlorine and bromine, and sulfonates like trifluoromethanesulfonate. Preferred protecting groups for —COOH groups are esters, while preferred protecting groups for —NH₂ groups are amides and phthalimides. As an alternative, the terminal hydroxy groups in the PFPE alcohol of formula (II) can be transformed into a leaving group E as defined above and reacted with a compound of formula HO—B*-T wherein B* and T are as defined above.

Typically, (PFPE-M) wherein A and/or A′ represent groups of formula (a¹) as defined above can be obtained by reaction of a PFPE alcohol (II) with a compound of formula E-C*ₐₗₖ-T, wherein E, C*ₐₗₖ and T are as defined above. A preferred example of (PFPE-M) wherein group (a¹) is —CF₂CH₂O—CH₂-T can be obtained by reaction of a PFPE-diol (II) with an ester of a 2-halo-acetic acid, for example with 2-chloroethyl acetate.

(PFPE-M) wherein A and A′ represent groups of formula (b¹) as defined above can be synthesised by condensation reaction of a PFPE alcohol (II) with a diol of the type HO-alkylene-OH or by ring-opening reaction of a PFPE alcohol (II) with ethylene oxide or propylene oxide, to provide a hydroxyl compound which is either reacted with compound of formula E-C*ₐₗₖ-T or submitted to conversion of the hydroxyl end groups into leaving groups E as defined above and reacted with a compound of formula HO—C*ₐₗₖ-T.

(PFPE-M) wherein A and A′ represent groups (c¹) as defined above can be synthesised by reaction of a (PFPE-M) wherein A and/or A′ represent groups —CF₂CH₂O-alkylene-COOH or derivative thereof with a diamine or aminoacid of formula NH₂-alkylene-T, wherein alkylene and T are as defined above.

(PFPE-M) wherein x is 1 and L comprises a W¹ group of formula —CH₂NHR¹— in which R¹ is as defined above can be obtained by reaction of a PFPE alcohol (II), whose hydroxyl end groups E have been transformed into leaving groups E, with a compound of formula R¹HN—B*-T wherein R¹, B* and T are as defined above.

For example, (PFPE-M) wherein A and/or A′ represent groups of formula (d¹) as defined above can be synthesised by reaction of a PFPE alcohol (II) with an amine of formula R¹NH-alkylene-T, wherein R¹ and alkylene are as defined above and wherein T is optionally in a protected form.

(PFPE-M) wherein A and/or A′ represent groups of formula (e¹) as defined above can be synthesised by reaction of a PFPE alcohol (II) with a polyamine of formula R¹NH-(alkylene-NR¹)ₙ₋₁alkylene-NHR¹, wherein n and R¹ are as defined above, followed by reaction with a compound of formula E-C*ₐₗₖ-T, wherein E, C and T are as defined above.

(PFPE-M) wherein A and/or A′ represent groups of formula (f¹) as defined above can be synthesised by reaction of a PFPE alcohol (II) with an aminoacid of formula R¹NH-alkylene-T, followed by reaction with a compound of formula HO-alkylene-T, wherein R¹ and T are as defined above.

(PFPE-M) wherein A and/or A′ represent groups of formula (g¹) as defined above can be synthesised by reaction of a PFPE alcohol (II) with an aminoacid of formula R¹NH-alkylene-COOH, followed by reaction with a compound of formula NH₂-alkylene-T, wherein R¹ and T are as defined above.

As an alternative, (PFPE-M) wherein x is 1 and L comprises a W₁ group of formula —CH₂NHR¹— in which R¹ is as defined above can be obtained by converting a PFPE alcohol (II) into the corresponding sulfonic ester derivative, by reaction, for example, with CF₃SO₂F and reacting the sulfonic diester with anhydrous liquid ammonia to provide a PFPE diamine of formula (III) below:

Y′—O—R_{f}—CF₂CH₂NH₂ (III)

wherein R_{f} is as defined above and Y′ is —CF₂CH₂NH₂ or is the same as Y as defined above.

PFPE diamine (III) can be reacted with a compound of formula E-B*-T, wherein E, B* and T are as defined above.

(PFPE-M) wherein x is 1 and L comprises a W¹ group of formula —C(O)NH— can be obtained using as precursor a PFPE diacid of formula (IV) below:

Y″—O—R_{f}—CF₂COOH (IV)

in which R_{f} is as defined above and Y″ is —CF₂COOH or is the same as Y as defined above

or a reactive derivative thereof, preferably an ester derivative, typically a methyl or ethyl ester derivative.

Suitable PFPE ester derivatives of PFPE acids (IV) can be conveniently obtained as disclosed, for example, in U.S. Pat. No. 5,371,272 (AUSIMONT SPA).

PFPE acids (IV) or reactive derivatives thereof can be reacted with compounds of formula N₂H—B*-T, wherein B* and T are as defined above.

In particular, (PFPE-M) wherein A and A′ comply with formulae (h¹)-(l¹) as defined above can be prepared by reaction of an ester derivative of an acid (IV) with a compound of formula NH₂—(C*ₐₗₖ)-T, NH₂—(R*ₐₗᵢ)-T or NH₂—(R*ₐᵣ)-T.

For the sake of clarity and accuracy, it is pointed out that, in certain instances, the synthesis of (PFPE-M) of formula (I) above can lead to the formation of a certain amount of dimeric or polymeric by-products; for example, in the synthesis of a mixture wherein A and/or A′ represent groups of formula:

—CF₂CH₂O-alkylene-C(O)NH-alkylene-NH₂; (c¹*)

dimeric by products of formula:

A-O—R_{f}—CF₂CH₂O-alkylene-C(O)NH-alkylene-NH(O)C-alkylene-OCH₂CF₂—R_{f}—O-A

are obtained, due to the reaction of a diamine of formula: H₂N-alkylene-NH₂ with diacid of formula: HOOC-alkylene-O—CH₂CF₂—O—R_{f}—CF₂CH₂O-alkylene-COOH in a molar amount of 1 to 2.

Furthermore, in the synthesis of a (PFPE-NN) by reaction of a PFPE alcohol with an amine of formula R¹NH-alkylene-NH₂ in which R¹ is other than hydrogen, mixtures of regioisomers, for instance those of formulae:

H₂N-alkylene-N(R¹)—CH₂CF₂—O—R_{f}—CF₂CH₂—N(R¹)-alkylene-NH₂.

HN-alkylene-NH-CH₂CF₂—O—R_{f}-CF₂CH₂—NH-alkylene-NH(R¹) (R¹)

can be obtained.

Thus, for the purposes of the present invention, the expressions “PFPE-NN”, “PFPE-AA”, are meant to encompass also any dimeric or polymeric by-products or regioisomers which may be formed in their synthesis.

### Monomer (C)

Monomer (C) (herein after also referred to as “PSIL-M”) is a functional polyorganosiloxane selected from at least one of a:
diamino-polyorganosiloxane (PSIL-NN) and a
dicarboxy-polyorganosiloxane (PSIL-AA).

In greater detail, PSIL-M is a polymer or a derivative thereof able to form amido bonds comprising repeating units of formula (U):

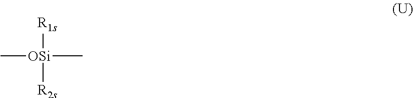

in which R₁ₛ and R₂ₛ, equal to or different from one another, are independently selected from hydrogen, straight or branched (halo)alkyl and aryl, with the proviso that at least one of R₁ₛ and R₂ₛ is not hydrogen. Preferred alkyl groups are those comprising from 1 to 4 carbon atoms; more preferably, both R₁ₛ and R₂ₛ are methyl.

PSIL-NN has two ends, each comprising one amino functionality.

PSIL-AA has two ends, each comprising one carboxyl functionality.

PSIL-M can be represented with the following formula (V):

Tₛ-Bₛ—Rₛᵢₗ—Bₛ-Tₛ (V)

in which each Tₛ represents an amino group, namely primary amino group (—NH₂) or a carboxy group (—COOH) or a derivative thereof as defined above; Bₛ represents a straight or branched alkylene chain optionally comprising one or more ethereal oxygen atoms, and Rₛᵢₗ represents a chain comprising repeating units (U) as defined above and having a molecular weight typically ranging from 800 to 5000.

Preferably, chain Rₛᵢₗ complies with formula (Rₛᵢₗ-I):

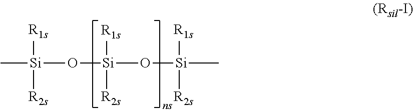

wherein R₁ₛ and R₂ₛ are as defined above and ns is an integer from 5 to 100.

Preferably, groups R₁ₛ and R₂ₛ are straight or branched alkyl groups, preferably comprising from 1 to 6 carbon atoms, preferably from 1 to 4 carbon atoms, more preferably 1 or 2 carbon atoms. Most preferably, all R₁ₛ and R₂ₛ groups are methyl groups, i.e. PSIL-M comprises a polydimethylsiloxane chain.

Preferably, alkylene chain Bₛ comprises from 2 to 20 carbon atoms and can optionally comprise one or more ethereal oxygen atoms. Preferably, chain Bₛ comprises from 2 to 6 carbon atoms, more preferably from 2 to 6 carbon atoms, even more preferably from 2 to 6 carbon atoms.

PSIL-M of formula (V) suitable for the present invention are available on the market, or can be obtained according to methods known in the art.

A convenient example of PSIL-NN is bis-aminopropyl polydimethyl siloxane of formula:

H₂N(CH₂)₃Si(CH₃)₂O[Si(CH₃)₂O]ₙₛSi(CH₃)₂(CH₂)₃NH₂

in which ns is as defined above.

Preferred polyamides (PA) according to the present invention are those wherein the overall amount of recurring units derived from monomers (B) and (C) ranges from 0.1% to 8% wt, preferably from 0.25% to 3% wt with respect to the overall weight of recurring units derived from monomers (A), (B) and (C).

It is preferred that in polyamides (PA) the weight ratio between the recurring units derived from PFPE-M and the recurring units derived from PSIL-M is higher than 1. Preferably, the ratio between PFPE-M and PSIL-M recurring units ranges from 11 to 3; more preferably, the ratio is 3.

Preferred polyamides (PA) of the invention are those comprising recurring units derived from:
adipic acid and meta-xylylene-diamine as monomer (A);
a PFPE-M having an average functionality (F_{B}) higher than 1.80, wherein chain (R_{f}) complies with formula (R_{f}-III) and A and/or A′ is a group (a1) of formula —CF₂CH₂O—CH₂-T, in which T is a carboxyl group, preferably in its ester form, as monomer (B)
bis-aminopropyl polydimethyl siloxane as monomer (C)

wherein the overall amount of recurring units derived from monomers (B) and (C) ranges from 0.1% to 8% wt, preferably from 0.25% to 3% wt with respect to the overall weight of recurring units derived from monomers (A), (B) and (C). Preferably, the overall amount of recurring units derived from monomers (B) and (C) is 3% wt and the ratio between PFPE-M and PSIL-M is 3. It has been observed that, when the overall amount of recurring units derived from monomers (B) and (C) is 3% wt and the ratio between PFPE-M and PSIL-M is 3, an optimal balance between hydro- and olephobicity can be achieved, i.e. the polyamides of the invention maintains the improved olephobicity of the polyamides of WO 2015/097076 and, at the same time show a significant increase in hydrophobicity.

Further examples of convenient polyamides (PA) according to the present invention are those comprising recurring units derived from:
1,3-cyclohexanebis(methylamine), 1,10-decanediamine, terephthalic acid and isophthalic acid as monomer (A);
a PFPE-M having an average functionality (F_{B}) higher than 1.80 wherein chain (R_{f}) complies with formula (R_{f}-III) and A and/or A′ is a group (a1) of formula —CF₂Lₓ-T, in which Lx-T represents a group of formula:

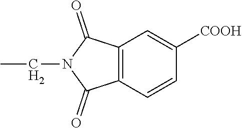 [SMILES: CCN1C(=O)c2ccc(C(=O)O)cc2C1=O]

bis-aminopropyl polydimethyl siloxane as monomer (C).

### Manufacture of Polyamides (PA)

Polyamides (PA) according to the present invention can be synthesised by means of a method which comprises mixing and reacting the monomers (A), (B) and (C) or derivatives thereof as defined above, said method being characterized in that the overall amount of monomers (B) and (C) or derivatives thereof ranges from 0.1% to 8% wt, preferably from 0.25% to 3% wt, with respect to the overall weight of monomers (A), (B) and (C) or derivatives thereof.

The method can be carried out according to procedures known in the art for the synthesis of polyamides.

### Properties and Uses of Polyamides (PA)

In addition to showing high hydro- and oleo-repellence, the polyamides (PA) of the invention are endowed with high thermal stability and favourable mechanical properties. It has also been observed that the polyamides of the invention are endowed with anti-stain properties.

In view of the above, polyamides (PA) can be used for the manufacture and/or surface treatment of formed articles for a variety of consumer and industrial applications, like medical, automotive, electrical, electronic and printing applications and in the manufacture of food packagings. Polyamides (PA) can be used alone or in admixture with one another; moreover, one or more polyamide (PA) can be used as such or they can be blended with further ingredients and/or additives to obtain (PA) compositions. Accordingly, the present invention relates to formed articles containing one or more polyamide (PA) or a composition comprising one or more polyamide (PA) in admixture with further ingredients and additives. Non-limiting examples of further ingredients and/or additives include heat-stabilizers, light and UV-light stabilizers, hydrolysis stabilizers, anti-oxidants, lubricants, plasticizers, colorants, pigments, antistatic agents, flame-retardant agents, nucleating agents, catalysts, mold-release agents, fragrances, blowing agents, viscosity modifiers, flow aids, glass fibers and the like. The kind and amount of ingredients and/or additives will be selected by the skilled person according to common practice, for example following the teaching of Plastics Additives Handbook, 5th ed., Hanser, 2001.

According to a preferred embodiment, the compositions comprise one or more polyamide (PA) in admixture with glass fibers. Typically, such compositions comprise from 10% to 70% wt polyamide with respect to the weight of the composition.

The invention further relates to a method for manufacturing formed articles comprising polyamides (PA) or compositions of polyamides (PA), said method comprising:
melting one or more polyamide (PA) or a composition of a polyamide (PA) to obtain a molten polyamide (PA) or molten polyamide composition;
casting the molten (PA) or (PA) composition into a mold and
cooling.

Non limiting examples of formed articles include articles for biomedical applications, fuel line hoses, miniature circuit breakers (MCB), electrical switches, smart devices and devices for printers. Particularly preferred examples of articles for biomedical applications are those in contact with biological fluids, such as membranes and catheters for hemodialysis.

Should the disclosure of any patents, patent applications, and publications which are incorporated herein by reference conflict with the description of the present application to the extent that it may render a term unclear, the present description shall take precedence.

The invention is illustrated in greater detail in the following Experimental Section by means of non-limiting Examples.

Should the disclosure of any patents, patent applications, and publications which are incorporated herein by reference conflict with the description of the present application to the extent that it may render a term unclear, the present description shall take precedence.

### EXPERIMENTAL SECTION

### Materials

Adipic acid was obtained from Loba Chemie Pvt. Ltd and used as received. Meta-xylenediamine (MXDA) was obtained from TCI co. Ltd. and used as received.

1,3-Cyclohexanebis(methylamine), 1,10-decanediamine, terephthalic acid and isophthalic acid were obtained from Sigma-Aldrich®.

OCV EC10 983 glass fiber (chopped strands) was obtained from Owens Corning and glass fiber #CSG 3PA-820 was obtained from Nitto Boseki Co. Ltd.

White pigment TiO₂ (Ti-pure, R-104) was purchased from DuPont.

Bis(3-aminopropyl) terminated poly(dimethyl siloxane) (Mₙ 2500) was purchased from Sigma-Aldrich® or from Gelest.

Hexafluoroisopropanol (HFIPA) was purchased from Sigma-Aldrich®.

The following PFPE alcohols, herein after referred to as (II-a) and (II-b), were obtained from Solvay Specialty Polymers Italy S.p.A.:

(II-a), complying with formula:

HOCH₂CF₂(OCF₂CF₂)ₐ₁(OCF₂)ₐ₂OCF₂CH₂OH

wherein:
a1/a2 is 2.5 and a1+a2 is selected in such a way that the M_{W} is 1580 (E_{W}=863)

and
the average —OH functionality is 1.83

(II-b) complying with formula:

HOCH₂CF₂(OCF₂CF₂)ₐ₁(OCF₂)ₐ₂OCF₂CH₂OH

wherein:
a1/a2 is 1.5 and a1+a2 is selected in such a way that the M_{W} is 2000 (E_{W}=1030)

and
the average functionality is 1.94.

The PFPE diethyl ester used for the synthesis of polyamides (E-6)-(E-18) and (CE-19) was prepared according to the procedure illustrated in the subsection “Synthesis of PFPE monomers”.

A diamine herein after referred to as (PFPE-NN-a), complying with formula:

NH₂CH₂CF₂(OCF₂CF₂)ₐ₁(OCF₂)ₐ₂OCF₂CH₂NH₂

wherein:
a1 and a2 are a1/a2 is 1.5,
M_{W} is 2040 (E_{W}=1051)
average functionality 1.94

was prepared from PFPE alcohol (II-b) following the procedure disclosed in U.S. Pat. No. 6,984,759 (SOLVAY SOLEXIS SPA) Apr. 8, 2004.

Diamine (PFPE-NN-a) was used as precursor for the synthesis of the phtalimido diacid monomer of formula (PFPE-AA-a) here below:

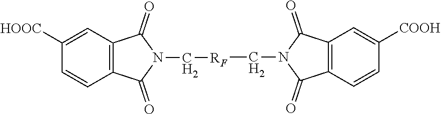

wherein:
R_{F}═CF₂(OCF₂)ₐ₂(OCF₂CF₂)ₐ₁OCF₂ with a1/a2=1 and a1+a2 selected in such a way as Mₙ=2375 (determined by NMR) average functionality (F)=1.94 and equivalent weight (E_{w})=1220

The monomer was used for the synthesis of polyamide (E-20).

### Synthesis of PFPE Monomers

### Synthesis of Diethyl Ester of PFPE Alcohol (II-a)

40 g t-BuOH and 19 g (170 meq) t-BuOK were charged in a ½ l reactor. 100 g (130 meq) PFPE alcohol (II-a) was added under stirring at room temperature.

The reaction mass was maintained under these conditions for 30′; then 19.7 g (170 meq) ClCH₂C(O)OEt was added and the internal temperature was raised to 80° C. for 12 hours. Thereafter, the reaction mass was cooled down to room temperature and 200 ml water containing 10% by weight 37% HCl was added; after separation of two phases, the bottom one was separated and dried, to provide 104 g title product, having the following structure (¹H-NMR and IR analyses):

EtO(O)CCH₂OCH₂CF₂O(CF₂CF₂O)ₘ(CF₂O)ₙCF₂CH₂OCH₂C(O)OEt

(m/n=2.5; M_{w}: 1793; E_{w}: 896, average functionality 1.87)

¹H-NMR: 4.2 (—CH₂ α to the —CF₂); 3.95 (—CH₂ α to the carbonyl group).

### Synthesis of Bis-Phtalimido Derivative of a Diamine (PFPE-NN-a) [Phtalimido Diacid Monomer (PFPE-AA-a)]

The phtalimido diacid monomer (PFPE-AA-a) was prepared by reacting (PFPE-NN-a) (50 g, 24.5 mmoles, 47.6 meq) with trimellitic anhydride (9.2 g, 48 meq) at 100° C. for 2 hours in the presence of DABCO [(1,4-diazabicyclo[2.2.2]octane)]. A sample was taken and analysed by FT-IR, then it was heated at 140° C. for 2 further hours to provide the final product. The final product was isolated by conventional work-up, including an acidic water washing and final drying in vacuum at 80° C.

The Mn of the PFPE bis-phtalimide was 2375 and its average functionality 1.94.

### Methods

### NMR and IR Analyses

¹H-NMR spectra was recorded on a Bruker AV 400 MHz instrument.

FT-IR measurements were carried out on a Perkin Elmer instrument.

### Gel Permeation Chromatography (GPC)

Molecular weights were determined on a GPC equipment comprising a Waters® HPLC pump (model no. 515), a Shodex refractive index (RI) detector (model no. 109), a Waters® column oven (operating from room temperature to 150° C.) maintained at 40° C. during the analysis, a set of two mini mixed B SEC columns and mini mix B guard column (from Agilent), a Clarity SEC integration software (Version 5.0.00.323).

HFIPA/0.05M potassium trifluoro acetate (KTFAT) at a flow rate of 0.4 mL/minute was used as mobile phase.

The system was calibrated using the set of A-1004-REF internal calibrations standard samples.

### Chemical Titration

End group analysis was performed for amine and carboxylic acid end groups. The amine end group was determined by titration (Metrohm auto titrator with pH electrode). About 0.4 g sample was dissolved in HFIPA with stirring and was titrated against 0.05 N HCl.

For the titration of acid end groups, about 0.3 g sample was dissolved in 6 ml of o-cresol and heated at 70° C. with stirring. The resulting solution was cooled to room temperature and added with 6 ml chloroform and formaldehyde and titrated against 0.05 N aqueous HCl.

### Thermal Analyses

Thermogravimetric analyses (TGA) were performed on a Q500 TA thermogravimetric analyzer in N₂ atmosphere with a heating rate of 20 C/min.

Differential scanning calorimetry (DSC) measurements were performed on a Q2000 TA differential scanning calorimeter in N₂ atmosphere.

### Contact Angles

Contact angles data were recorded using a DataPhysics—OCA 20 instrument using the Sessile Drop method with ellipse fitting on solution casted thin films from HFIPA as well as on molded specimens. Water and n-hexadecane were used as reference solvents for measuring hydrophobicity and oleophobicity respectively, with a dosing volume 2 μL.

### Mechanical Properties

Tensile properties were determined according to the ISO-527-1 standard method with pre-load=5 N; Speed, E-Modulus=1 mm/min; Speed, yield point=5 mm/min; test speed=5 mm/min.

Notched impact strength properties were determined according to the ISO-180 standard using a Zwick/Roell—HIT25P impact tester equipped with a 2.75 J hammer.

### Processing (Extrusion)

The polyamides and glass fibres [OCV EC10 983 (4.5 mm)] were co-extruded on a ZSK-26 twin screw extruder at a ratio of 50:50. The polyamides were fed through the gravimetric feeder in zone-1 of the extruder comprising 12 zones. The temperature of the barrel was in the range of 220-270° C. The glass fibres were fed from zone 7 through a side stuffier via a gravimetric feeder. The melt pressure was 50-53 bar, the screw rpm was 170/min, torque was around 50% and the output was 10 kg/h.

For mustard stain resistance tests, polyamide pellets were used and white pigment (TiO₂) were mixed and fed from zone 1 of the extruder from the gravimetric feeder and 50% glass fibres (Nitto Boseki #CSG 3PA 820) was introduced through the zone seven of a ZSK-26 twin screw extruder. The temperature of the instrument ranged from 260 to 270° C. The melt pressure was 50-53 bar, the screw was 170/min, the torque was around 50% and the output was 10 kg/h. The extrudate strands were cooled and pelletized using conventional equipment.

### Processing (Injection Molding)

Injection moulding was carried out using the EV 75 injection molding machine from Sumitomo having a clamp tonnage of 75 metric ton. The temperature range was from 265 to 280° C. The mold temperature controller was set at 140-165° C. The cooling cycle time was fixed at 35-50 sec. Under these setup conditions, appropriate specimens such as ISO 527-1 tensile test pieces, impact bars and color plaques were molded. For mustard stain resistance tests, the extruded pellets were dried at 120° C. for 18 h and then molded on a Sumitomo 75 TON injection molding machine. The temperature range was 300° C.-315° C. with 800 bar injection pressure and injection speed of 38 cc/sec. The mould temperature controller was set at 140-165° C. and the holding time was 5-7 sec. The cooling cycle time was fixed at 45 sec. Under these setup conditions colour plaques (75×50×2.6 mm) were molded.

### Determination of the Color I Index of Polyamide Compositions

The CIE L*, a*, b* and yellowness index (YI) values were determined using an X-Rite Color i7 spectrophotometer under the following measurement conditions against mode: reflection, light type: D65-10, measuring diaphragm: small area view, 9 mm illuminated. With use of the YI values of references and sample corresponding to CIELAB system, the yellowness color difference ΔYI was calculated by following equation:

ΔYI=YI sample−YI reference

The color difference ΔE between the color locations (L*a*b*) reference and (L*a*b*) sample was calculated in accordance with ISO 12647 and ISO 13655 as a Euclidean difference as follows:

$$Δ E = \sqrt{{( {L}_{sample}^{*} - {L}_{reference}^{*} )}^{2} + {( {a}_{sample}^{*} - {a}_{reference}^{*} )}^{2} + {( {b}_{sample}^{*} - {b}_{reference}^{*} )}^{2}}$$

### Evaluation of Stain Resistance—Mustard Stain Test on Polyamide Blends

The mustard stain test on specimens obtained from polyamide blends containing 5% TiO₂ were measured according to the procedure disclosed in the Methods Section. The test was performed on injection molded color plaque specimens (dimension: 75×50×2.65 mm). For this purpose, after injection molding, the molded test specimens were stored for at least 40 h at room temperature in a desiccator. The staining agent (yellow mustard) was applied in such a way as to completely and homogeneously cover a 30×20 mm area of each specimen, the rest area of the same specimen being regarded as untreated reference. The specimens were stored for more than 10 hours in a temperature controlled humidity chamber at 65° C. and relative humidity of 90%. After storage, the test specimens were cooled to 23° C. and the surface was cleaned with an isopropanol-water (50:50) solution with the aid of a soft tissue until any adhering residues of mustard were completely removed. Once the specimens were dried, the L*, a*, b* and yellowness index (YI) values were determined, and the ΔE and ΔYI values were calculated therefrom. ΔYI ≤5, ΔE ≤3 refer to absence of stains (also visually observed by naked eye).

### Syntheses of Polyamides

### EXAMPLE 1 (COMPARATIVE)

### Synthesis of a Polyamide Consisting of Recurring Units Derived from adipic acid and m-xylene diamine [Polyamide (CE-1)]

Adipic acid (510.12 g, 3.490 moles) and m-xylenediamine (475.34 g, 3.490 moles) were charged in an autoclave vessel and the head of autoclave was closed. Nitrogen gas was purged in for few minutes and then all valves were closed. The temperature was set at 200° C. until the reaction mass melted, then stirring was started at 125 rpm. An initial torque of about 3 to 4 was observed. The reaction temperature was increased of 10° C./10 min up to 250° C. and pressure was maintained at 4.5 kg/cm² for 1 hour, then released slowly in about 30 minutes. As soon as pressure was released, the torque of reaction mixture started to rise slowly then rapidly up to 16-17 (when the pressure dropped to zero). At this point, nitrogen purging was re-started. The resulting polyamide (CE-1) was discharged through the vessel bottom valve into an ice-cold water bath.

### EXAMPLES 2-5 (COMPARATIVE)

### Synthesis of Polyamides Consisting of Recurring Units Derived from adipic acid, m-xylene diamine and a PSIL-NN [Polyamides (CE-2)-(CE-5)]

The procedure illustrated in Example 1 was followed, with the difference that also bis(3-aminopropyl) terminated poly(dimethyl siloxane) (2AP-PDMS) was charged in the autoclave vessel at the beginning of the reaction.

The amounts of reagents for each polyamide (CE-2)-(CE-5) is reported in Table 1 below.

TABLE 1

| | | | | | | | wt % |
|---|---|---|---|---|---|---|---|
| | | | | | | | 2AP-PDMS |
| | | | | | | | over adipic |
| | Adipic | | m-xylene | | | | acid and |
| | acid (g, | | diamine | | (2AP-PDMS) | | m-xylene |
| Polyamide | moles) | | (g, moles) | | (g, moles) | | diamine |
| CE-2 | 511.49 | g, | 475.05 | g, | 29.64 | g, | 3 |
| | 3.5 | moles | 3.488 | moles | 0.1185 | moles | |
| CE-3 | 511.49 | g, | 475.05 | g, | 19.76 | g, | 2 |
| | 3.5 | moles | 3.488 | moles | 0.0079 | moles | |
| CE-4 | 511.49 | g, | 476.17 | g, | 9.88 | g, | 1 |
| | 3.5 | moles | 3.496 | moles | 0.0039 | moles | |
| CE-5 | 511.49 | g, | 474.02 | g, | 49.40 | g | 5 |
| | 3.5 | moles | 3.480 | moles | 0.0197 | moles | |

Table 2 below reports the molecular weights values of polyamides (CE-1)-(CE-5) and their polydispersity indexes (PDI)

TABLE 2

| Polyamide | Mₙ | M_{w} | PDI |
|---|---|---|---|
| CE-1 | 11590 | 27480 | 2.36 |
| CE-2 | 12558 | 28620 | 2.27 |
| CE-3 | 9140 | 23240 | 2.54 |
| CE-4 | 10700 | 28900 | 2.69 |
| CE-5 | 11170 | 25160 | 2.25 |

### EXAMPLES 6-18

### Synthesis of Polyamides [Polyamide (E-6)-(E-18)] Consisting of Recurring Units Derived from adipic acid, m-xylene diamine, a PSIL-NN and a PFPE-AA Diester

The procedure illustrated in Example 1 was followed, with the difference that also 2AP-PDMS and the diethyl ester of PFPE alcohol (II-a) were charged in the autoclave vessel at the beginning of the reaction.

### EXAMPLE 19 (COMPARATIVE)

### Synthesis of a Polyamide Consisting of Recurring Units Derived from adipic acid, m-xylene diamine and a PFPE-AA Diester

The procedure of Examples 6-18 was followed with the difference that 2AP-PDMS was not used.

The amounts of reagents for each polyamide (E6)-(E-18) and (CE-19) is reported in Table 3 below.

TABLE 3

| | | | | | | wt % |
|---|---|---|---|---|---|---|
| | | | | | | diester of |
| | | | | | wt % | PFPE |
| | | | | | 2AP- | alcohol |
| | | | | | PDMS | (II-a) |
| | | | | Diester of | over adipic | over adipic |
| | | m-xylene | (2AP- | PFPE | acid and | acid and |
| | Adipic acid | diamine | PDMS) | alcohol | m-xylene | m-xylene |
| Polyamide | (g, moles) | (g, moles) | (g, moles) | (II-a) | diamine | diamine |
| E-6 | 510.12 g, | 476.16 g, | 9.882 g, | 19.76 g, | 1 | 2 |
| | 3.490 | 3.496 | 0.00395 | 0.00939 | | |
| | moles | moles | moles | moles | | |
| E-7 | 510.46 g, | 475.90 g, | 14.82 g, | 14.82 g, | 1.5 | 1.5 |
| | 3.492 | 3.494 | 0.0059 | 0.0070 | | |
| | moles | moles | moles | moles | | |
| E-8 | 510.12 g, | 475.05 g, | 29.64 g, | 19.76 g, | 3 | 2 |
| | 3.490 | 3.488 | 0.0118 | 0.0093 | | |
| | moles | moles | moles | moles | | |
| E-9 | 510.8 g, | 475.05 g, | 29.64 g, | 9.88 g, | 3 | 1 |
| | 3.495 | 3.488 | 0.0118 | 0.0046 | | |
| | moles | moles | moles | moles | | |
| E-10 | 509.42 g, | 475.05 g, | 29.64 g, | 29.64 g, | 3 | 3 |
| | 3.485 | 3.488 | 0.0118 | 0.0141 | | |
| | moles | moles | moles | moles | | |
| E-11 | 509.42 g, | 475.62 g, | 19.76 g, | 29.64 g, | 2 | 3 |
| | 3.485 | 3.492 | 0.0070 | 0.0141 | | |
| | moles | moles | moles | moles | | |
| E-12 | 509.42 g, | 476.17 g, | 9.88 g, | 29.64 g, | 1 | 3 |
| | 3.485 | 3.496 | 0.0039 | 0.0141 | | |
| | moles | moles | moles | moles | | |
| E-13 | 510.12 g, | 475.62 g, | 19.76 g, | 19.76 g, | 2 | 2 |
| | 3.490 | 3.492 | 0.0079 | 0.0093 | | |
| | moles | moles | moles | moles | | |
| E-14 | 510.8 g, | 476.17 g, | 9.88 g, | 9.88 g, | 1 | 1 |
| | 3.495 | 3.496 | 0.0039 | 0.0039 | | |
| | moles | moles | moles | moles | | |
| E-15 | 510.12 g, | 476.17 g, | 9.88 g, | 19.76 g, | 1 | 2 |
| | 3.490 | 3.496 | 0.0039 | 0.0093 | | |
| | moles | moles | moles | moles | | |
| E-16 | 509.6 g, | 476.57 g, | 2.47 g, | 27.2 g, | 0.25 | 2.75 |
| | 3.487 | 3.499 | 0.0009 | 0.0129 | | |
| | moles | moles | moles | moles | | |
| E-17 | 510.12 g, | 476.44 g, | 4.94 g, | 19.76 g, | 0.5 | 2 |
| | 3.490 | 3.498 | 0.0019 | 0.0093 | | |
| | moles | moles | moles | moles | | |
| E-18 | 509.94 g, | 476.29 g, | 7.41 g, | 22.23 g, | 0.75 | 2.25 |
| | 3.489 | 3.497 | 0.0030 | 0.0106 | | |
| | moles | moles | moles | moles | | |
| CE-19 | 509.42 g, | 476.7 g, | / | 29.64 g, | 0 | 3 |
| | 3.485 | 3.5 | | 0.0141 | | |
| | moles | moles | | moles | | |

Table 4 below reports the molecular weights values of the polyamides (E-6)-(CE-19) and their polydispersity indexes (PDI)

TABLE 4

| Polyamide | Mₙ | M_{w} | PDI |
|---|---|---|---|
| E-6 | 12740 | 28780 | 2.26 |
| E-7 | 11130 | 25980 | 2.33 |
| E-8 | 9250 | 21560 | 2.32 |
| E-9 | 9530 | 21960 | 2.30 |
| E-10 | 11530 | 24630 | 2.13 |
| E-11 | 9670 | 23840 | 2.46 |
| E-12 | 10700 | 22900 | 2.14 |
| E-13 | 9149 | 21688 | 2.37 |
| E-14 | 10284 | 23538 | 2.28 |
| E-15 | 12749 | 28787 | 2.26 |
| E-16 | 12440 | 28560 | 2.26 |
| E-17 | 9120 | 23780 | 2.6 |
| E-18 | 7890 | 20700 | 2.62 |
| CE-19 | 11285 | 26485 | 3.35 |

The molecular weights reported in Tables 2 and 4 showed that polyamides (CE-2)-(CE-5), (CE-19) and (E-6)-(E-18) had similar molecular weights and PDI to those of (CE-1); however, ¹H-NMR analyses confirmed the incorporation of PDMS and PFPE segments in the polyamide backbone.

### EXAMPLE 20

### Synthesis of a Polyamide Consisting of Recurring Units Derived from 1,3-cyclohexanebis (methylamine), 1,10-decandiamine, terephthalic acid, isophthalic acid, a PSIL-NN and a PFPE-AA [3 wt % PSIL-NN, 4 wt % PFPE-AA, Mn=11675, Mw=33366, Polydispersity Index 2.8)

1,3-Cyclohexanebis(methylamine) (139.9 g, 0.984 mol, 0.4 eq), 1,10 decane diamine (252.63 g, 1.467 mol, 0.595 eq), terephthalic acid (122.61 g, 0.738 mol, 0.3 eq), isophthalic acid (285.7 g, 1.72 mol, 0.693 eq), the diacid monomer PFPE-AA-a (32.15 g, 0.0135 mol, 0.0070 eq) and 2-AP-PDMS (25 g, 0.01 mol, 0.005 eq) were charged in the autoclave vessel and the head of autoclave was closed. Nitrogen gas was purged into it for few minutes, then purging was stopped. After making sure that all valves were closed, the temperature was set at 200° C. until the reaction mass melted, then stirring was started. The rpm of was set at 160 and initial torque was observed around 3 to 4; at that point the reaction temperature increased by 10° C./10 mins up to 250° C. Meanwhile, pressure also increased until it reached 16.5 kg/cm²; this value was maintained pressure for 30 min, then released slowly within 30 min. When the pressure release started, the torque of reaction increased slowly, then rapidly up to 20-22 when pressure became zero. At that time, nitrogen was purged and the polyamide was discharged through the bottom valve of the vessel into a cold water bath, then dried and ground for further analyses.

### EXAMPLE 21 (COMPARATIVE)

### Synthesis of a Polyamide Consisting of Recurring Units Derived from 1,3-cyclohexane bis(methylamine), 1,10-decandiamine, terephthalic acid and isophthalic acid

The procedure of Example 20 was followed, with the difference that the diacid monomer PFPE-AA-a and the 2-AP-PDMS were not used.

### Evaluation of Properties of the Polyamides

### Contact Angle Studies on Solution Casted Films

Contact angle studies were performed on thin solution casted films from HFIP. The presence of PDMS units in combination with PFPE units improved hydrophobicity and suppressed oleophobicity.

The results of the measurements are reported in Table 5 below.

TABLE 5

| | Contact angle | Contact angle vs. |
|---|---|---|
| Polyamide | vs. water | hexadecane |
| CE-1 | 73.6 ± 0.6 | 11.3 ± 1.1 |
| CE-2 | 105.7 ± 0.8 | 38.6 ± 1.2 |
| CE-3 | 102.6 ± 0.2 | 36.7 ± 0.8 |
| CE-5 | 101.9 ± 0.3 | 31.6 ± 1.2 |
| E-7 | 102.7 ± 0.5 | 60.0 ± 1.1 |
| E-8 | 101.2 ± 0.5 | 61.9 ± 0.5 |
| E-9 | 102.8 ± 0.5 | 56.0 ± 1.6 |
| E-10 | 101.2 ± 0.3 | 63.0 ± 0.8 |
| E-11 | 101.9 ± 0.3 | 65.0 ± 1.5 |
| E-12 | 102.9 ± 0.6 | 65.4 ± 1.1 |
| E-13 | 97.5 ± 1.9 | 63.0 ± 0.9 |
| E-14 | 97.0 ± 0.9 | 60.0 ± 1.3 |
| E-15 | 100.3 ± 1.7 | 66.5 ± 0.6 |
| CE-19 | 100.0 ± 2.3 | 69.0 ± 0.4 |

The results reported in Table 5 show that films obtained from the polyamides of the invention [films from (E-7)-(E-15)] have higher hydro- and oleophobicity than films obtained from polyamide (CE-1). Furthermore, films obtained from the polyamides of the invention maintain the hydrophobicity of films obtained from polyamides modified only with PDMS [films from (CE-2), (CE-3) and (CE-5)], but are endowed with a significantly higher hydrophobicity.

### Contact Angle Studies on Molded Specimens

Contact angles measurements carried out on molded specimens under ambient conditions (DAM: Dry as Molded) and after annealing at 120° C. for about 24 hours. Hydrophobicity and oleophobicity were measured against water and n-hexadecane respectively. The results reported in Table 6 below show that specimens obtained from the polyamides of the invention (E-15)-(E-17) are endowed with much higher hydro- and oleophobicity than specimens obtained from the polyamide (CE-1). Furthermore, the specimens obtained from the polyamides of the invention have slightly lower hydrophobicity than specimens from polyamides modified only with PDMS segments, but significantly higher oleophobicity. The best results were obtained for specimens from polyamides (E-16) and (E-17).

TABLE 6

| | Contact angle vs. | Contact angle vs. |
|---|---|---|
| | water (after | hexadecane (after |
| | annealing at | annealing at |
| Polyamide | 120° C. for 10 hrs) | 120° C. for 10 hrs) |
| CE-1 | 79.2 ± 0.53 | 21.1 ± 2.46 |
| CE-2 | 109.5 ± 1.90 | 29.3 ± 1.11 |
| CE-3 | 103.7 ± 0.68 | 35.3 ± 0.62 |
| CE-4 | 100.4 ± 0.59 | 36.4 ± 1.10 |
| E-15 | 97.0 ± 1.16 | 51.4 ± 1.67 |
| E-16 | 93.9 ± 0.97 | 64.2 ± 0.46 |
| E-17 | 94.0 ± 1.39 | 63.9 ± 0.40 |
| E-18 | 96.1 ± 0.63 | 64.4 ± 0.64 |
| CE-19 | 89.5 ± 0.77 | 65.0 ± 0.46 |

### Thermal Stability

Thermal stability was determined by thermogravimetric analysis (TGA) and differential scanning calorimetry (DSC). For all polyamides, about 10% weight loss was observed around 400° C. with a similar degradation pattern.

The results showed that the polyamides of the invention are as stable as non-modified polyamides and polyamides modified only with PDMS. Representative results are reported in Table 7 [polyamide (E-7)] versus comparative polyamides (CE-1), (CE-2) and (CE-19).

TABLE 7

| | | | T (° C.) at which |
|---|---|---|---|
| | | | 10% wt loss was |
| | Tₘ | T_{g} | observed in TGA |
| Polyamide | (° C.) | (° C.) | (N₂ atmosphere) |
| CE-1 | 237 | 84.6 | 410 |
| CE-2 | 237 | 86.4 | 401 |
| E-7 | 237 | 90.7 | 404 |
| CE-19 | 237 | 86.5 | 404 |

In Table 7
Tₘ = melting transition in DSC;
T_{g} = glass transition during DSC heating cycle.

### Mechanical Properties

The mechanical properties of the polyamides of the invention filled with 50% glass fibers were measured as explained above.

Representative results are reported in Table 8 below.

TABLE 8

| | | | | Strain | IZOD |
|---|---|---|---|---|---|
| | | Tensile | Tensile | at | Notched |
| | | strength | modulus | break | Impact |
| Sample | Polyamide | (MPa) | (GPa) | )%) | (KJ/m²) |
| 1 | CE-1 | 274 ± 4.1 | 19.6 ± 0.5 | 1.35 ± 0.04 | 11.79 ± 0.45 |
| 2 | CE-2 | 252 ± 14.0 | 18.8 ± 0.1 | 1.28 ± 0.10 | 13.40 ± 0.02 |
| 3 | E-15 | 275 ± 10.4 | 19.6 ± 0.3 | 1.34 ± 0.09 | 13.19 ± 0.02 |
| 4 | E-16 | 271 ± 11.9 | 19.8 ± 0.6 | 1.30 ± 0.10 | 14.24 ± 0.03 |
| 5 | E-17 | 286 ± 3.3 | 19.6 ± 0.2 | 1.39 ± 0.04 | 13.31 ± 0.01 |
| 6 | E-18 | 282 ± 7.1 | 19.8 ± 0.1 | 1.36 ± 0.06 | 14.18 ± 0.02 |

The results reported in Table 8 show that glass-filled polyamides of the invention have a tensile strength similar to that of a glass-filled non-modified polyamide (CE-1) and higher than glass-filled polyamides modified with PDMS only (CE-2). Tensile modulus of glass-filled polyamides of the invention is similar to that of a glass filled non-modified polyamide (CE-1), while a slight reduction was observed in case of glass-filled polyamides modified with PDMS only (CE-2). Notched impact strength of glass-filled polyamides of the invention was higher than that of glass-filled non-modified polyamide (CE-1) and comparable with that of glass-filled polyamides modified with PDMS only (CE-2).

### Mustard Stain Resistance

Mustard stain resistance tests were carried out as illustrated in the Materials and Methods section. Table 9 below reports the result obtained on injection-molded slabs of polyamide E-20 and of polyamide CE-21.

TABLE 9

| Polyamide | % wt PFPE | % wt PDMS | % wt F | Δ YI | ΔE |
|---|---|---|---|---|---|
| CE-21 | 0 | 0 | 0 | 8.8 | 7 |
| E-20 | 2.0 | 1.5 | 0.6 | 6.1 | 4.2 |

The results show that the presence of PFPE and PDMS units increases resistance to mustard stains over non-modified polyamides.

1. A polyamide (PA) consisting of recurring units derived from monomers (A), (B) and (C) or derivatives thereof wherein:
monomer (A) is selected from at least one of:
(i) a mixture of:
one or more aliphatic, cycloaliphatic or aromatic diamine(s) [amine (NN)] and
one or more aliphatic, cycloaliphatic or aromatic dicarboxylic acid(s) [acid (AA)]; and
(ii) one or more aminoacid(s) [aminoacid (AN)] or lactam(s) [lactam (L)];
monomer (B) is a functional (per)fluoropolyether selected from at least one of:
a (per)fluoropolyether dicarboxylic acid (PFPE-AA) and
a (per)fluoropolyether diamine (PFPE-NN); and
monomer (C) is a functional polyorganosiloxane selected from at least one of:
a diamino-polyorganosiloxane (PSIL-NN) and
a dicarboxylic-polyorganosiloxane (PSIL-AA)
characterized in that the overall amount of recurring units derived from monomers (B) and (C) or derivatives thereof ranges from 0.1 to 20% wt with respect to the overall weight of recurring units derived from monomers (A), (B) and (C).

2. The polyamide of claim 1 wherein the overall amount of recurring units derived from monomers (B) and (C) ranges from 0.1% to 8% wt with respect to the overall weight of recurring units derived from monomers (A), (B) and (C).

3. The polyamide of claim 2 wherein the overall amount of recurring units derived from monomers (B) and (C) ranges from 0.25% to 3% wt with respect to the overall weight of recurring units derived from monomers (A), (B) and (C).

4. The polyamide of claim 1 wherein the weight ratio between the recurring units derived from monomer (B) and the recurring units derived from monomer (C) is higher than 1.

5. The polyamide of claim 1 wherein monomer (A) is a mixture of:
one or more aliphatic, cycloaliphatic or aromatic diamine(s) [amine (NN)]; and
one or more aliphatic, cycloaliphatic or aromatic dicarboxylic acid(s) [acid (AA)].

6. The polyamide of claim 1 wherein monomer (B) is a functional (per)fluoropolyether comprising a chain of formula (R_{f}-III):
—(CF₂CF₂O)ₐ₁(CF₂O)ₐ₂— (R_{f}-III)
wherein:
a1, and a2 are integers >0 such that the number average molecular weight is between 400 and 5,000, with the ratio a2/a1 ranging from 0.3 to 3.

7. The polyamide of claim 6 wherein monomer (B) complies with formula (I):
A-O—R_{f}-A′ (I)
wherein:
R_{f} is a chain of formula (R_{f}-III) as defined in claim 6;
A and A′, equal to or different from one another, represent a C₁-C₃ haloalkyl group or a group of formula:
CF₂-Lₓ-T
in which:
L represents a bivalent radical selected from:
(a) a C₁-C₂₀ straight or branched C₃-C₂₀ alkylene chain (Cₐₗₖ), optionally containing one or more heteroatoms selected from O, N, S and P and/or one or more groups of formula —C(O)—, —C(O)O—, —OC(O)O—, —C(O)NH—, —NHC(O)NH— and —C(O)S—, said chain optionally containing a (heterocyclo)aliphatic ring (Rₐₗᵢ) or (heterocycloaromatic) ring (Rₐᵣ) as defined herein below;
(b) a C₃-C₁₀ cycloaliphatic ring (Rₐₗᵢ), optionally substituted with one or more straight or branched alkyl groups, and optionally containing one or more heteroatoms selected from N, O, S or groups of formula —C(O)—, —C(O)O— and —C(O)NH; optionally linked to or condensed with a further ring (Rₐₗᵢ) or with a C₅-C₁₂ aromatic ring (Rₐᵣ) optionally containing one or more heteroatoms selected from N, O, S and optionally being substituted with one or more straight or branched alkyl groups;
(c) a C₅-C₁₂ aromatic ring (Rₐᵣ), optionally containing one or more heteroatoms selected from N, O, or S; optionally being substituted with one or more straight or branched alkyl groups; and optionally linked to or condensed with another equal or different ring (Rₐᵣ);
x is 0 or 1;
T is a —COOH or —NHR_{B} group, wherein R_{B} is hydrogen or a straight or branched alkyl group.

8. A polyamide according to claim 1 wherein monomer (C) is a polymer comprising repeating units of formula (U): 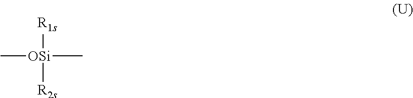
in which R₁ₛ and R₂ₛ, equal to or different from one another, are independently selected from hydrogen, straight or branched (halo)alkyl and aryl, with the proviso that at least one of R₁ₛ and R₂ₛ is not hydrogen.

9. The polyamide of claim 8 wherein monomer (C) complies with formula (V):
Tₛ-Bₛ—Rₛᵢₗ—Bₛ-Tₛ (V)
wherein
each Tₛ represents an amino group or a carboxy group (—COOH);
Bₛ represents a straight or branched alkylene chain, and
Rₛᵢₗ represents a chain comprising repeating units (U) as defined in claim 8 and having a molecular weight typically ranging from 800 to 5000.

10. A polyamide composition comprising one or more polyamides (PA) of claim 1 in admixture with further ingredients and/or additives.

11. The composition of claim 10, wherein the one or more polyamides (PA) is in admixture with glass fibers.

12. A method of manufacturing a polyamide composition, said method comprising mixing together one or more polyamides (PA) of claim 1 with further ingredients and additives.

13. A formed article containing one or more polyamides (PA) according to claim 1.

14. A formed article according to claim 13, said article being selected from medical articles, fuel line hoses, miniature circuit breakers, electrical switches, smart devices and food packagings.

15. A method of manufacturing a formed article, said method comprising:
melting one or more polyamides (PA) according to claim 1 to obtain a molten polyamide (PA);
casting the molten polyamide (PA) into a mold; and
cooling.

16. The polyamide of claim 9 wherein each Tₛ represents a primary amino group (—NH₂).

17. A formed article containing a polyamide composition of claim 10.

18. A formed article according to claim 17, said article being selected from medical articles, fuel line hoses, miniature circuit breakers, electrical switches, smart devices and food packagings.

19. A method of manufacturing a formed article, said method comprising:
melting a polyamide composition according to claim 10 to obtain a molten composition;
casting the molten composition into a mold; and
cooling.
